(19) United States
(12) Patent Application Publication
(10) Pub. No.: US 2008/0109746 A1
(43) Pub. Date: May 8, 2008

(54) Method And Device For Accepting Electronic Appliances

(75) Inventor: Boris Mayer, Bonn (DE)

Correspondence Address: International IP Law Group, P.O. BOX 691927, HOUSTON, TX, 77269-1927, US

(73) Assignee: DEUTSCHE POST AG, Bonn (DE)

(21) Appl. No.: 11/791,594

(22) PCT Filed: Nov. 9, 2005
(86) PCT No.: PCT/EP05/12007

§ 371 Date: Sep. 25, 2007

(30) Foreign Application Priority Data
Dec. 3, 2004 (DE) 10 2004 058 562.8

(51) Int. Cl. G07F 7/06; G06F 3/048

(52) U.S. Cl. 715/772; 340/5.9

(57) ABSTRACT

A method for accepting electronic equipment at an acceptance device is disclosed. An exemplary embodiment of the method comprises recognizing the equipment with the acceptance device, associating the equipment with a recipient address, applying the associated recipient address onto an addressing indici attached to the equipment, removing the equipment from the acceptance device, and transporting the equipment to the recipient address.

The invention relates to a method for accepting electronic equipment at an acceptance device.

The invention also relates to a device for accepting electronic equipment.

Before the backdrop of growing environmental awareness, manufacturers of electronic equipment are increasingly being compelled to take back electronic equipment that they have sold and to dispose of it in an environmentally sound manner or to recover it. In particular, now that EU Directive 2002/96/EC on waste electrical and electronic equipment (WEEE) has been transposed into national law in the member states of the European Union, a need has arisen for effective and widespread systems for taking back electronic equipment. The equipment involved includes large household appliances as well as smaller items of electronic equipment such as mobile telephones, laptops, video game consoles, sports equipment with electronic components, small medical equipment, notebooks and electronic organizers.

When it comes returning large equipment, it is practical to personally take the equipment back to a manufacturer or to a collecting station. In a customer-friendly alternative, the equipment can also be picked up from the customer. In the case of smaller equipment, other methods can be used, aside from personally dropping off the equipment. A known modality for returning mobile telephones is that the customer puts them into an envelope that is readily available and that is then sent to the seller/manufacturer of the mobile telephone or directly to a recovery company free of charge for the customer. This is an inexpensive way for customers to properly dispose of their mobile telephones. However, it entails the effort of having to pick up an envelope, for example, at a branch office of the mobile service provider and having to drop off the envelope with the mobile telephone in a mailbox, if applicable. Even if the customer can drop off the envelope at a branch office, this is not a flexible method for him since branch offices located downtown are often difficult to reach because of traffic. As a result, there is a need for a system for taking back electronic equipment that provides the customer with the most flexible and simple return modality possible.

In other applications involving the return of objects, for example, in the realm of returning beverage cans and bottles, it is a known procedure to employ automatic devices for accepting empty containers. These devices are usually capable of recognizing different types of containers, in some cases, of sorting them and of giving the appropriate deposit back in the form of cash or vouchers.

For example, international patent application WO 02/089078 A1 describes a device for accepting packaging, with which the packaging is placed into an acceptance station. The packaging is identified and, on the basis of the identification, a monetary amount, a voucher and/or a transaction report is issued. The device also comprises a sorting unit that transports the packaging to various sorting stations within the device on the basis of this identification.

The objective of the invention is to propose a method and a device for accepting electronic equipment from a customer in order to offer the customer as well as the manufacturer the simplest possible return/acceptance modality.

According to the invention, this objective is achieved by a method having the features of the independent claim 1. Advantageous refinements of the method ensue from the subordinate claims 2 to 18. The objective is also achieved by a device according to claim 19. Advantageous embodiments of the device likewise ensue from the subordinate claims 20 to 30.

The method according to the invention for accepting electronic equipment at an acceptance device comprises several steps. The method proposes that the equipment is recognized by means of a detector system connected to the device. Preferably, the electronic equipment is placed into the housing of the device so that it can be recognized. After the equipment has been recognized, a computer associates the equipment with a recipient address that is then applied onto an addressing means attached to the item of equipment. The recipient address is preferably stored in a database and associated with an equipment manufacturer and/or with a type of equipment. The equipment is removed from the device and transported to the recipient address.

The equipment can be recognized by the detector system using various methods. For example, the recognition can be carried out by optically detecting a barcode located on the equipment or by reading out an RFID transponder located on or in the equipment. In a simple embodiment, the recognition can also be carried out by evaluating a manual input by a customer or else by generating an image of the equipment in an optical recognition procedure and comparing it to images of electronic equipment in a database.

In an especially preferred embodiment of the invention, in the device, the electronic equipment is inserted into shipping packaging that has an addressing means onto which the recipient address is applied. Here, it can prove to be advantageous to place several items of electronic equipment bearing the same associated recipient address into shared shipping packaging.

After an item of electronic equipment has been accepted, the device preferably generates a transaction report and issues it via an issuing means. If the customer is given a refund for returning an item of electronic equipment, the device has an issuing means for this purpose that issues the monetary amount after accepting the item of electronic equipment. The monetary amount can be issued as cash, as a voucher or as a credit to the account of a customer. The credit of the monetary amount to the account of a customer is preferably carried out by a central administration unit connected to the device.

The invention also encompasses a device for accepting electronic equipment, said device comprising a housing with an acceptance opening, whereby the acceptance opening is connected to a detector system that has means for recognizing the equipment. The device also has a database and computing means connected to the detector system in order to determine a recipient address and to associate the recipient address with the equipment. It also comprises means for applying the recipient address onto an addressing means attached to the equipment. The device also has an input means so that a user can enter information, display means for displaying information to a user, issuing means for issuing a transaction report, and means for issuing a monetary amount. The device is advantageously connected to a central administration unit.

In an especially preferred embodiment of the invention, the device is integrated into an electronic parcel deposit box facility having one or more lockable storage compartments and the electronic equipment is placed into a storage compartment of the parcel deposit box facility.

The detector system can comprise various means for recognizing an item of electronic equipment. For example, the detector system can have one or more scanners for reading in a barcode or means for reading out an RFID transponder. Preferably, the detector system also comprises optical means for acquiring an image of the equipment and means for comparing a detected image of an item of equipment to images of electronic equipment stored in the database.

In an especially preferred embodiment of the invention, the device comprises means for placing an item of electronic equipment into shipping packaging. This shipping packaging is preferably an envelope or a box. The device can also have means for collecting several items of electronic equipment bearing the same associated recipient address in shared shipping packaging.

The method according to the invention, together with the appertaining device, has the essential advantage that it offers customers a very simple way to return electronic equipment for disposal or recovery. The method also has the advantage that equipment made by multiple manufacturers can be accepted at several shared devices without each manufacturer having to set up its own collecting system.

The devices are preferably set up at various readily accessible places so that the customer can flexibly choose or can even spontaneously decide to drop off an item of electronic equipment. Since the customer does not need to have shipping packaging and does not need to know the manufacturer's address in order to return an item of equipment, the customer can drop off the item of equipment at the device without much trouble.

Thanks to the connection to a central administration unit, information about equipment that is to be accepted can be updated in the database and the operation of the device can be adapted to changing requirements. Due to the flexible association of recipient addresses, the device also allows direct shipment to various manufacturers, recovery companies or intermediate stations.

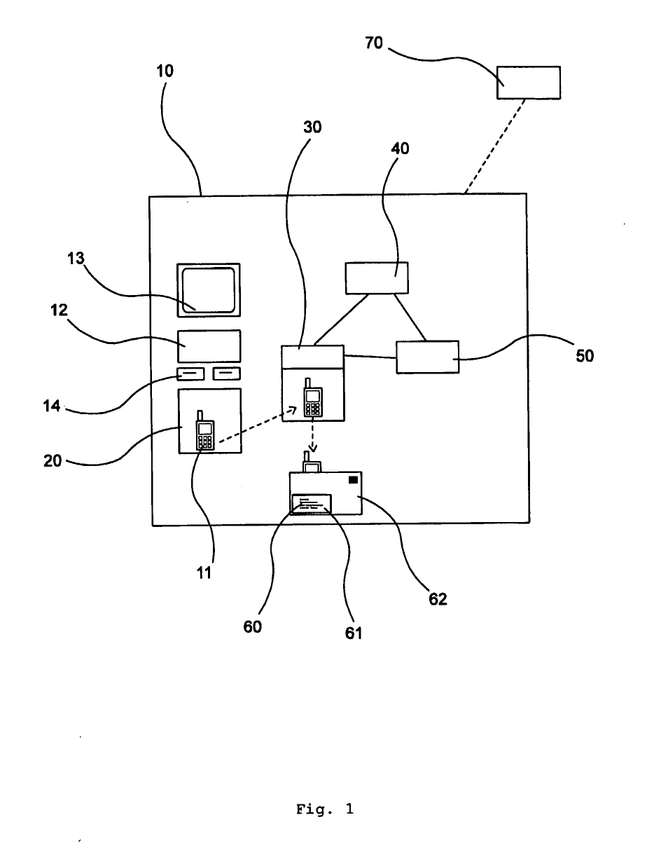

Additional advantages, special features and practical refinements of the invention can be gleaned from the subordinate claims and from the presentation below of preferred embodiments, making reference to the drawing in FIG. 1.

FIG. 1 schematically shows an especially preferred embodiment of the device according to the invention for accepting electronic equipment. The device preferably consists of a housing 10 into which a customer can insert an item of electronic equipment 11 that is to be returned through an acceptance opening 20. The acceptance opening can be configured, for example, as a flap or lock through which a customer can insert an item of equipment in such a way that it is not damaged when it is inserted.

The device preferably has input and display means such as a keyboard 12, a monitor 13 or a touchscreen for carrying out an operating dialog with the customer. Moreover, an issuing means 14 is also advantageous for issuing a transaction report or a receipt to the customer pertaining to the return of an item of electronic equipment. The device can also have means for issuing a monetary amount in the form of cash or a voucher.

The device can be set up at numerous locations, whereby preferably several devices are provided. In order to ensure the greatest possible flexibility, the devices are located at places that are readily accessible to customers and are preferably available 24 hours per day. Consequently, customers can drop off an item of electronic equipment at any time that is convenient for them. It is especially advantageous to set up the devices at places such as gas stations, department stores or supermarkets that are frequently visited by customers.

In order to protect the devices from environmental influences such as weather or damage, they are configured so as to be weatherproof and/or damage-proof like conventional vending machines or product-return machines. In an especially preferred embodiment of the invention, the device is connected to a device having a different function or else integrated into it. For example, it has proven to be advantageous to integrate the device into an electronic parcel deposit box facility. Electronic parcel deposit box facilities are used especially in the postal sector and they have one or more lockable storage compartments that are used to release mail to customers who can pick up the mail at the parcel deposit box facility at a point in time of their choosing. Since service personnel drive to such parcel deposit box facilities in order to pick up or drop off mailpieces, electronic equipment that is provided with a recipient address can likewise be picked up on these delivery routes and forwarded to a postal transport and delivery process.

It is especially advantageous to carry out the method according to the invention in such a way that electronic equipment 11 is placed into a storage compartment of an electronic parcel deposit box facility. Moreover, the recipient address can be associated with the appertaining compartment or else several items of equipment can be collected in one compartment.

When the device according to the invention is integrated into a facility with a different function, the two devices can be functionally completely separate from each other or else several components can be used by both of them. For example, it can be advantageous to use one acceptance opening, an input or display means or a control unit for the joint operation of various facilities.

The device has a detector system 30 to which the electronic equipment 11 is taken after being dropped off by the customer. The detector system serves for the recognition of the equipment and can be located inside the housing or separate from it. If the device is configured to accept only one kind of electronic equipment, then it is not absolutely necessary to recognize the equipment if it is assumed that a customer will only drop off one type of equipment. However, it has proven to be advantageous to check the type of returned equipment and to refuse to accept it if the checking procedure comes up with a negative result.

Various technologies can be used to recognize an item of equipment. In the process, these technologies can be used separately from each other or in parallel. Which technology is used for recognizing an item of equipment can be specified automatically or else on the basis of an entry by the customer. For example, the customer can use the input means 12 to enter which type of equipment is being returned, after which a suitable recognition method can be actuated. Moreover, the customer can indicate which identification such as barcodes or an RFID transponder the equipment has so that the appropriate technology can be actuated for reading in a barcode. If the equipment does not have an unambiguous identification, for example, optical detection methods can be used.

If there is a barcode on the equipment, this can be detected by a barcode scanner of the detector system 30. For this purpose, it can be necessary for the item of electronic equipment to be placed into the detector system in a certain position. This can be done, for example, in that instructions are displayed on the monitor for the customer or else sensors, conveying and rotating mechanisms place the item of equipment into a certain position in which the barcode can be detected. In another embodiment of the invention, the detector system 30 is equipped with several scanners so that barcodes in different positions can be detected. In another embodiment of the invention, an item of electronic equipment is provided with an RFID transponder that is read out in the detector system 30. Generally known devices for reading out transponders can be used for this purpose.

The information stored in a barcode or transponder is evaluated and at least the manufacturer or dealer that takes back the equipment is ascertained. In this process, the manufacturer/dealer can be ascertained directly from the barcode information or else from a database 40. The database 40 can be located inside the housing 10 or else separate from it. For instance, it can be advantageous to use a central database that is continuously updated with information about manufacturers, possible equipment and recipient addresses.

With barcode and RFID identification, other information can be read out in addition to the dealer or manufacturer. For example, the detected information can already have the recipient address stored in it to which the equipment is to be sent. In this case, a computing means 50 can directly associate the address with the item of equipment and the address is applied onto an addressing means 61 attached to the equipment. If no recipient address is stored in the identification means of the equipment, this can be ascertained from the database 40.

If the equipment does not have an unambiguous identification means, suitable physical methods can be employed for the recognition of the item of equipment. For example, optical recognition methods can be used in which an image of the equipment is taken and compared to images of electronic equipment stored in the database 40. The comparison can be rendered more precise by additional parameters such as the weight of the item, which is ascertained by an integrated set of scales. As additional parameters, the measured volume of the item of equipment can be used for the comparison. If the comparison shows that the image of the equipment matches stored data pertaining to an item of equipment, this can be displayed to the customer on the monitor 13, after which the customer can confirm the ascertained type of equipment.

Moreover, in a simple embodiment of the invention, it can be provided for the detector system not to use a special method for the recognition of the item of equipment but rather for it to be connected to an input means 12 of the device and for the information about the type of equipment to be obtained on the basis of an entry by the customer. In this case, it can be provided for the customer to directly enter the equipment type and/or the manufacturer of the equipment and, if applicable, already the recipient address.

In an especially preferred embodiment of the invention, the equipment is placed into shipping packaging 62 after the recognition step. In the case of smaller items of equipment such as mobile telephones, electronic organizers, etc. this packaging is preferably an envelope or a box. A recipient address 60 is associated with the item of equipment and this address is applied onto an addressing means 61. This can be, for instance, an address label that is applied onto the envelope. However, the recipient address can also be printed directly onto the envelope. The recipient address can be written onto the addressing means as plain text or as a barcode.

It can be advantageous for several items of equipment having the same recipient address to be placed into shared shipping packaging and for the packaging to be provided with the shared address. This can be achieved, for example, in that equipment bearing the same recipient address is first collected in the device and then provided with the shared recipient address at the end of a predefined period of time. For this purpose, the equipment can be collected in a shared container and then placed into shipping packaging. Another possibility is to immediately collect the equipment in shared shipping packaging that is provided with the shared recipient address. In order to be able to accept the largest possible number of different types of electronic equipment in the device without the dimensions of the device becoming too large, it can be advantageous to only provide shared shipping packaging for recipient addresses that occur frequently and to provide collection containers for these, whereas other types of equipment are each placed into individual envelopes.

The association of the recipient address 61 by the computing means 50 can be carried out very flexibly. For example, it can be provided that certain equipment is sent to the manufacturer or dealer. If a manufacturer uses a certain recovery company for the return and/or recovery of electronic equipment, then equipment made by this manufacturer can be sent, for example, directly to the recovery company. Moreover, a distinction can be made according to the year of production or other criteria if different recovery companies are used for different types of equipment. The various recipient addresses are preferably stored in the database 40 and can be associated with an item of equipment by the computing means 50.

Typically, the acceptance of an item of electronic equipment by the device is free of charge. If this procedure involves costs for the customer, the device advantageously has means with which a fee can be paid. This is, for example, a means for the payment in the form of a cash sum or by using a card.

Moreover, it can be provided that, when a customer returns an item of equipment, he also receives a monetary amount along with a transaction report. The monetary amount pertaining to an item of equipment is preferably likewise stored in the database 40. The monetary amount stored in the database can vary and can be determined, for example, as a function of the type of equipment, the age of the equipment or certain special campaigns. A monetary amount for the return of an item of electronic equipment can be issued, for example, in the same manner as in return systems for beverage cans and bottles, using cash or vouchers. In one embodiment of the invention, the monetary amount is credited to the account of a customer.

For various embodiments of the invention, it can be advantageous for the device to be connected to a manufacturer whose equipment is accepted at the device. This can be effectuated with a direct connection to the manufacturer or with an indirect connection via a central administration unit 70 that is connected to several manufacturers. The central administration unit 70 offers the advantage that the procedures at several devices for accepting electronic equipment can be administered centrally. This includes, for example, the updating of the database 40 or the accounting of monetary amounts issued at the device. If a manufacturer refunds a certain monetary amount to a customer for returning an item of electronic equipment, and if this amount is paid out to the customer in advance by the operator of the device, then the central administration system settles the account for this payment with the manufacturer. The settlement of accounts for the performance can also entail the refund of a fee for the transportation of the equipment to the manufacturer or to a recovery company. If no monetary amount is issued to the customer but rather if this amount is credited to a customer's account, the credit is preferably likewise processed with the manufacturer via the central administration unit. For example, when the customer purchases a mobile telephone, he can receive a credit towards the purchase price by returning a phone. The central administration unit can also be used to transmit data to a manufacturer about equipment that has been accepted by a device. For instance, the number and/or the types of accepted equipment can be recorded and stored. This and other information can be transmitted to the manufacturer, for example, electronically as a file, so that the manufacturer is informed about accepted equipment, types of equipment, locations of the device in question, etc.

### LIST OF REFERENCE NUMERALS

10 acceptance device, housing
11 electronic equipment, mobile telephone
12 input means, keyboard
13 display means, monitor
14 issuing means for transaction report
20 acceptance opening
30 detector system
40 database
50 computing means
60 recipient address
61 addressing means, label
62 shipping packaging
70 central administration unit

1-30. (canceled)

31. A method for accepting electronic equipment at an acceptance device, the method comprising:
recognizing the equipment with the acceptance device;
associating the equipment with a recipient address;
applying the associated recipient address onto an addressing indicium attached to the equipment;
removing the equipment from the acceptance device; and
transporting the equipment to the recipient address.

32. The method according to claim 31, comprising placing the equipment into a housing of the acceptance device so that the equipment can be recognized.

33. The method according to claim 1, wherein the acceptance device is integrated into an electronic parcel deposit box facility having one or more lockable storage compartments and the electronic equipment is placed into a storage compartment of the parcel deposit box facility.

34. The method according to claim 33, wherein the recipient address of the electronic equipment is associated with the storage compartment.

35. The method according to claim 31, comprising optically detecting a barcode located on the equipment.

36. The method according to claim 31, comprising reading an RFID transponder located on or in the equipment.

37. The method according to claim 31, comprising evaluating a manual input by a customer.

38. The method according to claim 31, comprising:
generating an image of the equipment; and
comparing the image to a previously generated image of the equipment.

39. The method according to claim 31, wherein the recipient address is stored in a database where it is associated with an equipment manufacturer and/or with a type of equipment.

40. The method according to claim 31, comprising inserting the equipment into shipping packaging onto which the recipient address is applied.

41. The method according to claim 31, comprising:
collecting a plurality of items of electronic equipment in the acceptance device, each of the plurality of items of electronic equipment sharing the recipient address; and
provided each of the plurality of items of electronic equipment with the shared recipient address.

42. The method according to claim 41, comprising:
collecting each of the plurality of items of electronic equipment in a container; and
placing the collected plurality of items of electronic equipment into a shared shipping package.

43. The method according to claim 31, wherein items of electronic equipment that have the same recipient address are placed into a common compartment of an electronic parcel deposit box facility into which the acceptance device is integrated.

44. The method according to claim 1, wherein the device is adapted to issue a monetary amount after accepting the equipment.

45. The method according to claim 44, wherein the monetary amount is issued as cash, as a voucher or as a credit to an account of a customer.

46. The method according to claim 45, wherein the credit of the monetary amount to the account of the customer is preferably carried out by a central administration unit connected to the device.

47. The method according to claim 31, comprising:
generating a transaction report after the equipment has been accepted; and
issuing the transaction report.

48. The method according to claim 31, wherein the equipment comprises a mobile telephone.

49. A device for accepting electronic equipment, comprising:
a housing with an acceptance opening, whereby the acceptance opening is associated with a detector system that is adapted to recognize the equipment;
a processor associated with the detector system, the processor being adapted to determine a recipient address and to associate the recipient address with the equipment; and
an addressing device that is adapted to apply the recipient address to an addressing indicium attached to the equipment.

50. The device according to claim 49, comprising:
an input device that is adapted to allow a user to enter information;
a display that is adapted to display information to a user; and
an issuing device that is adapted to issue a transaction report.

51. The device according to claim 49, wherein the device is integrated into an electronic parcel deposit box facility having one or more lockable storage compartments and the acceptance opening is formed by a storage compartment of the parcel deposit box facility.

52. The device according to claim 49, wherein the detector system comprises one or more scanners that are adapted to read a barcode.

53. The device according to claim 49, comprising an RFID reader that is adapted to receive information from an RFID transponder.

54. The device according to claims 49, wherein the detector system comprises:
an optical reader that is adapted to acquire an image of the equipment; and
a comparing device that is adapted to compare a detected image of the equipment to previously created images of electronic equipment stored in a database.

55. The device according to claims 49, comprising a packager that is adapted to place the equipment into shipping packaging.

56. The device according to claim 49, comprising a collector that is adapted to collect a plurality of items of electronic equipment that share a common associated recipient address.

57. The device according to claim 56, wherein the collector is adapted to collect the plurality of items of electronic equipment in a container and to place them into a shared shipping package.

58. The device according to claim 49, wherein the shipping package comprises an envelope or a box.

59. The device according to claim 49, comprising a monetary amount dispenser.

60. The device according to claim 49, wherein the device is connected to a central administration unit.

61. An acceptance device that is adapted to receive electronic equipment for shipment, the acceptance device comprising:
means for recognizing the equipment with the acceptance device;
means for associating the equipment with a recipient address;
means for applying the associated recipient address onto an addressing indicium attached to the equipment; and
means for removing the equipment from the acceptance device.
